(19) United States
(12) Patent Application Publication
(10) Pub. No.: US 2025/0371641 A1
(43) Pub. Date: Dec. 4, 2025

(54) SYSTEMS AND METHODS FOR CASINO CHIP REDEMPTION

(71) Applicant: NRT Technologies, Inc., Las Vegas, NV (US)

(72) Inventors: Michael Dominelli, Toronto (CA); Nasr F. Sattar, Las Vegas, NV (US); Reza Soltani, Toronto (CA); Michael Muhammad, Scarborough (CA)

(21) Appl. No.: 19/220,965

(22) Filed: May 28, 2025

Related U.S. Application Data
(60) Provisional application No. 63/652,418, filed on May 28, 2024.

(51) Int. Cl. G06Q 50/34; G01G 19/414; G06K 7/10; G06K 19/07; G06Q 30/018; G06V 20/66; G07C 9/00

(52) U.S. Cl. CPC G06Q 50/34; G01G 19/414; G06Q 30/0185; G06K 7/10297; G06K 19/0723; G06V 20/66; G07C 9/00896

(57) ABSTRACT

The present disclosure relates to an automated casino chip redemption system and method. The system enables casino patrons to redeem multiple casino chips simultaneously through an automated process that identifies, verifies, and processes the chips without manual counting. The system may employ various technologies, such as machine vision or RFID, to accurately determine chip values and authenticity. Upon verification, the system dispenses corresponding value to users through various payment methods. The automated approach improves efficiency, reduces wait times, and enhances security compared to traditional manual chip redemption processes.

### CROSS-REFERENCE TO RELATED APPLICATIONS

This application claims the benefit of U.S. Ser. No. 63/652,418, filed on May 28, 2024 and entitled SYSTEMS AND METHODS FOR CASINO CHIP REDEMPTION, the disclosure of which is incorporated herein by reference in its entirety.

### BACKGROUND

In casinos, players typically use chips as a substitute for cash to place bets and play various games. When a player is finished playing, they must redeem their chips for cash at a casino cage or cashier. The conventional process of redeeming chips involves several steps and has numerous drawbacks. Traditionally, when a player wishes to cash out, they must gather their chips and bring them to a designated cashier or cage window. The player hands the chips to the cashier, who then manually counts and verifies the chips' authenticity. This process is time-consuming, especially if the player has a large number of chips or if there are many players waiting to cash out.

The manual chip counting process is also prone to human error. Cashiers may miscount chips, leading to discrepancies and disputes with players. Additionally, the handling of chips by multiple individuals increases the risk of chip counterfeiting and theft. Another issue with the conventional chip redemption process is the potential for money laundering. Casinos are required to comply with strict anti-money laundering (AML) regulations, which involve tracking and reporting large cash transactions. However, the manual nature of the chip redemption process makes it difficult to accurately record and monitor these transactions.

Furthermore, the traditional chip redemption process often results in long wait times for players, especially during peak hours or when there are staffing shortages. This can lead to player frustration and dissatisfaction, negatively impacting the overall casino experience. From an operational perspective, the conventional chip redemption process is labor-intensive and requires significant staffing resources. Casinos must employ numerous cashiers to handle the volume of players cashing out, which increases labor costs and reduces efficiency.

In light of these problems and limitations, there is a need for an improved system and method for redeeming casino chips.

### BRIEF DESCRIPTION OF THE DRAWINGS

It is believed that certain embodiments will be better understood from the following description taken in conjunction with the accompanying drawings, in which like references indicate similar elements and in which:

FIG. 1 schematically depicts a chip redemption unit in accordance with one non-limiting embodiment.

FIG. 2 schematically depicts a chip redemption unit in accordance with one non-limiting embodiment.

FIG. 3 schematically depicts a chip redemption unit in accordance with one non-limiting embodiment.

FIG. 4 schematically depicts accessing a chip receptacle of a chip redemption unit in accordance with one non-limiting embodiment.

FIG. 5 schematically depicts accessing a chip receptacle of a chip redemption unit in accordance with one non-limiting embodiment.

FIG. 6 schematically depicts accessing a chip receptacle of a chip redemption unit in accordance with one non-limiting embodiment.

FIG. 7 schematically depicts a chip receptacle in accordance with one non-limiting embodiment.

FIG. 8 schematically depicts a chip receptacle in accordance with one non-limiting embodiment.

FIG. 9 schematically depicts a chip receptacle in accordance with one non-limiting embodiment.

FIG. 10 schematically depicts a chip receptacle in accordance with one non-limiting embodiment.

FIGS. 11A-11D schematically depict identifying and ejecting the bottom chip in a chip stack in accordance with one non-limiting embodiment.

FIG. 12 schematically depicts a chip receptacle in accordance with one non-limiting embodiment.

FIG. 13 schematically depicts a chip receptacle in accordance with one non-limiting embodiment.

FIG. 14 schematically depicts identifying chips in a chip stack in accordance with one non-limiting embodiment.

FIG. 15 schematically depicts a chip recognition system in accordance with one non-limiting embodiment.

FIG. 16 shows an operational progression of an example chip receptacle of a chip redemption unit in accordance with one non-limiting embodiment.

FIG. 17 schematically depicts a chip receptacle of a chip redemption kiosk having a pivoting chip tray.

### DETAILED DESCRIPTION

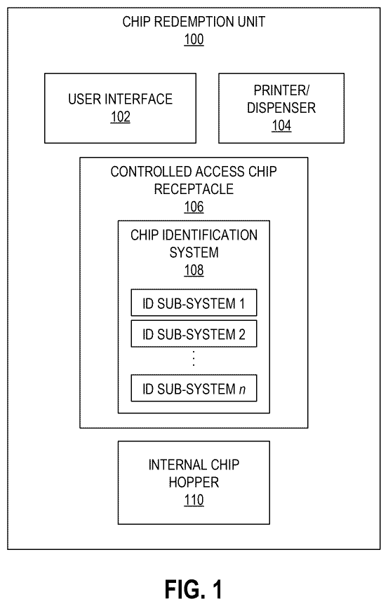

Various non-limiting embodiments of the present disclosure will now be described to provide an overall understanding of the principles of the structure, function, and use of systems, apparatuses, devices, and methods disclosed. One or more examples of these non-limiting embodiments are illustrated in the selected examples disclosed and described in detail with reference made to FIGS. 1-17 in the accompanying drawings. Those of ordinary skill in the art will understand that systems, apparatuses, devices, and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. In this disclosure, any identification of specific techniques, arrangements, etc., are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and include a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems, and can use other protocols, or operate at other layers in communication protocol stacks, than are described.

The chip redemption technology described herein provides an automated system for redeeming casino chips. In some cases, the system includes a chip receptacle configured to receive multiple casino chips simultaneously. The chip receptacle may allow users to deposit a stack or group of chips for processing, rather than requiring individual chip insertion.

A chip identification system may be positioned within the chip receptacle. The chip identification system may be configured to identify and verify the multiple casino chips placed in the receptacle. In some cases, the chip identification system employs various technologies to accurately determine the value and authenticity of the deposited chips. For example, the chip identification system may utilize machine vision, RFID scanning, or a combination of multiple identification methods.

The chip redemption system may include a controller operatively connected to the chip identification system. In some cases, the controller coordinates the overall operation of the redemption process, managing the identification of chips, calculation of total value, and initiation of value dispensing.

A value dispenser may be included in the chip redemption system. The value dispenser may be configured to provide a user with a value corresponding to the identified and verified multiple casino chips. In some cases, the value dispenser outputs cash, prints a ticket voucher, or credits a user's account based on the total value of the redeemed chips.

The chip redemption technology may incorporate various security features to prevent fraud and ensure accurate transactions. For example, the system may employ weight verification, UV/IR scanning for chip authenticity, or image analysis to detect counterfeit chips.

In some cases, the chip receptacle includes a movable gateway that can be secured during the identification process. This feature may prevent tampering with chips once they have been deposited for redemption.

The chip redemption system may interface with casino management systems to record transaction details, update player accounts, and maintain compliance with regulatory requirements. In some cases, the system captures and stores images of users during transactions for security and auditing purposes.

By automating the chip redemption process, this technology may improve efficiency, reduce human error, and enhance the overall gaming experience for casino patrons. The system may also assist casinos in managing chip inventory and tracking redemption patterns.

FIG. 1 schematically depicts a chip redemption unit 100 in accordance with one non-limiting embodiment. The chip redemption unit 100 can be a stand-alone unit or integrated into other unmanned or unattended equipment, such as an ATM or ticket voucher redemption unit, for example. The chip redemption unit 100 can include a user interface 102, such as a graphical user interface or other type of display. Depending on the implementation, the chip redemption unit 100 can include a printer and/or cash dispenser 104 that is configured to output a ticket voucher and/or cash to a user operating the unit. The chip redemption unit 100 can also include a controlled access chip receptacle 106 that is configured to receive chips from the user. One or more chip identification systems 108 can be operated within the controlled access chip receptacle 106 to identify each of the chips placed within the controlled access chip receptacle 106 by the user. As described in more detail below, example chip identification sub-systems can include, without limitation, vision systems, near field communication (NFC) systems, weight measurement systems, height measurement systems, UV lighting systems, IR lighting systems, and combinations thereof. Additionally, depending on the specific chip identification sub-systems being used, the environment of the controlled access chip receptacle 106 can be specially configured in an effort to increase the accuracy of the chip identification. By way of example, the controlled access chip receptacle 106 can include a lighting system that is configured to provide ample illumination of chips positioned within the controlled access chip receptacle 106. The chip redemption unit 100 can also include an internal chip hopper 110 that collects and securely holds redeemed chips until the hopper is emptied by an attendant.

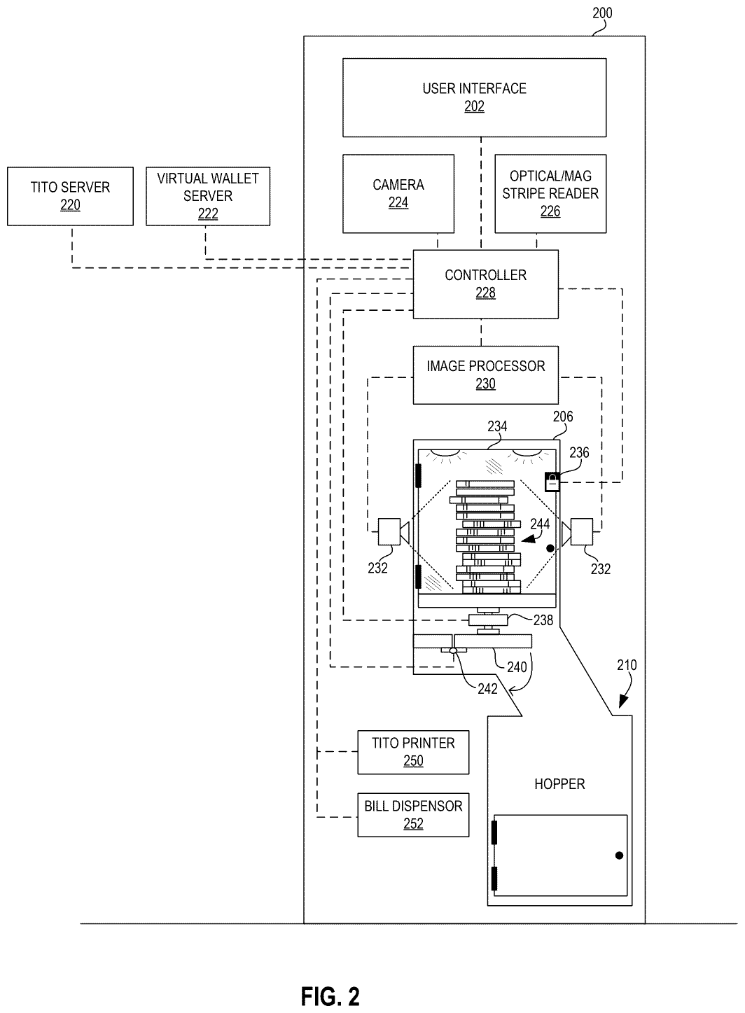

FIG. 2 schematically depicts a chip redemption unit 200 in accordance with one non-limiting embodiment. The chip redemption unit 200 can include a controller 228 that is in communication with, for example, a user interface 202, a camera 224, and an optical or magnetic stripe reader 226. The user interface 202 can be any suitable display or graphical user interface that provides instructions to a user. The camera 224 can be positioned and configured to collect either still images or video footage of the user interacting with the chip redemption unit 200. In some embodiments, the video feed of the camera 224 is displayed in real-time on the user interface 202 to inform the user that their interaction with the chip redemption unit 200 is being actively tracked. The chip redemption unit 200 can also include a controlled access chip receptacle 206. Access to the controlled access chip receptacle 206 is provided by a gateway 234. The gateway 234 can be temporality locked by an electronic lock 236, which is schematically shown in FIG. 2. In some embodiments, the gateway 234 is at least partially transparent to allow continuous observation of the chips during processing, although this disclosure is not so limited. In other embodiments, for example, the gateway 234 is opaque. In some embodiments, the gateway can be transitioned between transparent and opaque using smart glass, switchable glass, a smart film, or the like.

One or more cameras 232 can be positioned and calibrated to collect images of a chip stack 244 that is placed within the chip receptacle 206. Images from the cameras 232 can be provided to an image processor 230 for chip identification. While the image processor 230 is schematically shown in FIG. 2 as being local to the chip redemption unit 200, this disclosure is not so limited. In some embodiments, the image processor 230 can be located external to the chip redemption unit 200 and accessed via network communications. In some embodiments, the chip redemption unit 200 includes a chip scale 238, which is a specialized weighing device designed to accurately measure the weight of a stack of chips 244. The chip scale 238 can be calibrated to ensure the integrity and authenticity of the chips being processed by the chip redemption unit 200. In some embodiments, the calibration can account for the slight changes in chip weight that occur over time as a chip is circulated throughout a casino. The chip scale 238 can be, for example, a load cell that converts the mechanical force of a chip stack's weight into an electrical signal that can be processed by the controller 228. In some embodiments, the chip redemption unit 200 can also include an actuator 242, such as a solenoid, servo, stepper motor, or cam mechanism, for example, connected to a hinge attached to an arm 240 of the chip receptacle 206. When an electrical current is applied to the actuator 242 by the controller 228, the hinge can tilt the arm 240 and dump the redeemed chips 244 into a hopper 210 positioned inside the chip redemption unit 200. As a result of redeeming the chips 244, the user can be provided with cash or a cash equivalent using any suitable technique. For example, a TITO printer 250 can print a voucher or a bill dispenser 252 can dispense bills. As shown, in order to effectuate the redemption, the chip redemption unit 200 can be in networked communication with various servers or systems of the casino, such as a TITO server 220 and/or a virtual wallet server 222.

In accordance with one example chip redemption technique using the chip redemption unit 200, a user can open the gateway 234 of the chip receptacle 206 and place chips 244 inside. Once the gateway 234 is closed, it can be locked by the lock 236 during the chip identification process. The chip redemption unit 200 can utilize one or more chip identification techniques, such as using machine vision to visually recognize the value of each chip and determine a weight of the chip stack 244 to further ensure the accuracy of the determination. In some embodiments, other techniques can be used to prevent redemption of fraudulent chips, such as using UV or IR scans to confirm certain security features are present on the chips 244, for example. Once the value of the chips 244 has been determined, and while the gateway 234 remains locked, the determined value can be presented to the user via the user interface 202. If the user does not agree with the value, or otherwise decides to not redeem the chips, the user can provide such indication to the chip redemption unit 200 and the gateway 234 will unlock such that the user can retrieve the chips 244. If, however, the user wishes to complete the redemption process, the user can provide such indication to the chip redemption unit 200 and the actuator 242 can cause the arm 240 to dump the redeemed chips 244 into the hopper 210. The user can also be provided with the value of the chips in any of a variety of suitable formats, such as cash, a printed voucher, virtual funds, and so forth. In some cases, the chip redemption unit 200 can also instruct the user to provide suitable player identification, such as scanning a driver's license, a player's card, a QR code, and so forth. Such player identification can be logged along with other relevant transaction data for audit and compliance purposes.

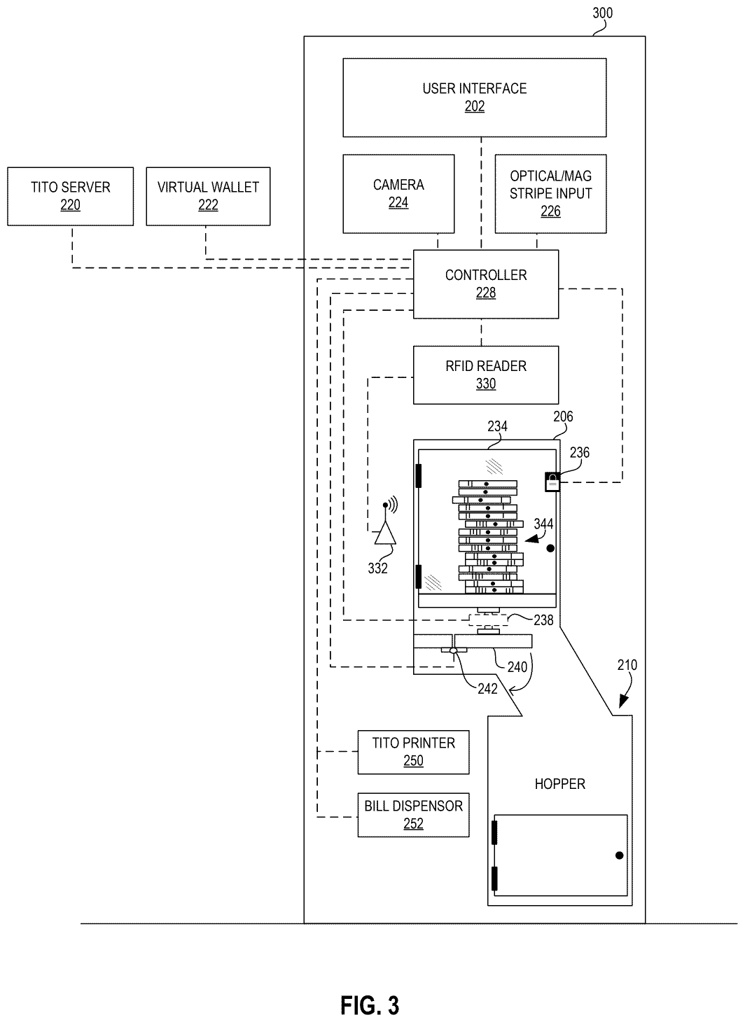

FIG. 3 schematically illustrates a chip redemption unit 300 in accordance with one non-limiting embodiment of the present invention. This embodiment shares many similarities with the chip redemption unit 200 depicted in FIG. 2 but incorporates near field communication technology for chip identification and authentication, rather than relying solely on machine vision. In this embodiment, the gaming chips 344 used in the casino are embedded with specialized tags, such as Radio-Frequency Identification (RFID) tags. Each chip 344 can contain its own RFID tag, which holds a distinct identifier code that allows the chip to be individually recognized, tracked, and authenticated by the chip redemption unit 300. The RFID tags can be securely embedded within the core of each chip during the manufacturing process.

The chip redemption unit 300 of FIG. 3 has a chip receptacle 206, which serves as a designated area for users to place their chips 344 for redemption. When the chips 344 are inserted into the chip receptacle 206, they come within range of the unit's built-in RFID antenna 332. This antenna is specifically designed to emit and receive radio waves at the frequency corresponding to the RFID tags embedded in the chips 344. With the chips 344 in the chip receptacle 206, an RFID reader 330 integrated into the chip redemption unit 300 can initiate a scanning process. The RFID reader 330 can generate a radio-frequency field through the antenna 332, which energizes the passive RFID tags within the chips. In response, the tags transmit their unique identifier codes back to the reader 330 via radio waves.

Upon receiving the identifier codes from the RFID tags, the chip redemption unit 300 can commence an authentication and verification process. In some embodiments, a combination of both RFID technology and machine vision is used for enhanced chip identification and security. While the RFID system provides rapid and reliable authentication based on the embedded tags, machine vision techniques, such as image recognition and optical character recognition described herein, can be employed to further validate the physical appearance and integrity of the chips.

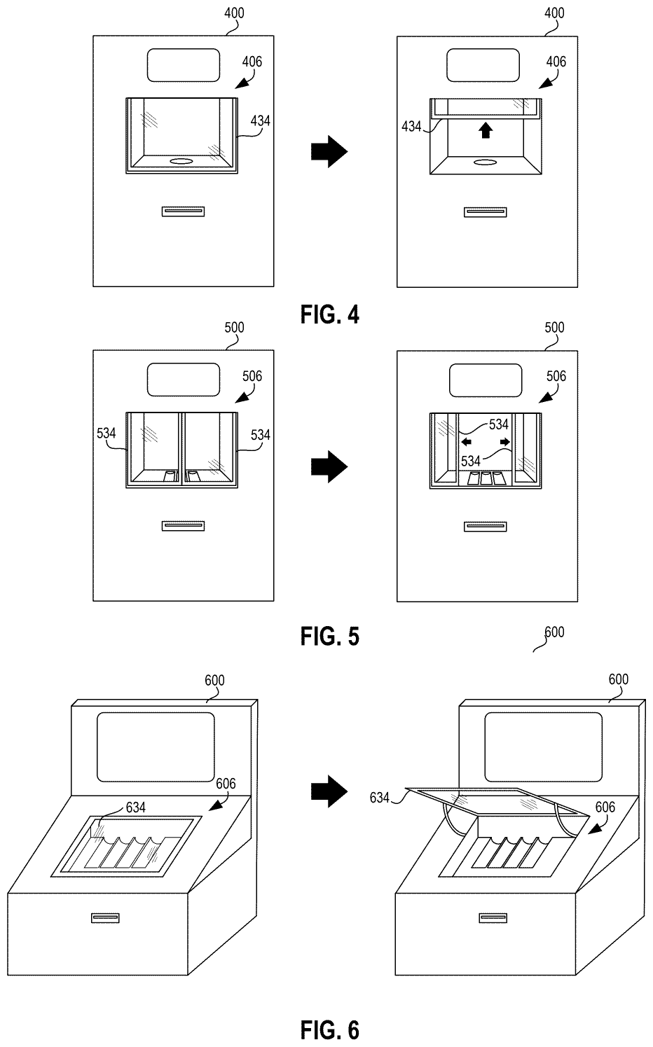

As is to be appreciated, the overall form factor, size, and implementation of chip redemption units in accordance with the present disclosure can vary. FIGS. 4-6 provide examples of non-limiting implementations. While these embodiments illustrate the use of a transparent gateway having particular configurations, this disclosure is not so limited. FIG. 4 schematically depicts accessing a chip receptacle 406 of a chip redemption unit 400 in accordance with one non-limiting embodiment. In this embodiment, a gateway 434 is provided as a vertically sliding panel that is movable between a first position and second position. In the first position, access to the chip receptacle 406 is restricted. In the second position, access to the chip receptacle 406 is permitted. FIG. 5 schematically depicts accessing a chip receptacle 506 of a chip redemption unit 500 in accordance with one non-limiting embodiment. In this embodiment, a gateway 534 is provided as a pair of horizontally sliding panels that are movable between a first position and second position. In the first position, access to the chip receptacle 506 is restricted. In the second position, access to the chip receptacle 506 is permitted. FIG. 6 schematically depicts accessing a chip receptacle 606 of a chip redemption unit 600 in accordance with one non-limiting embodiment. In this embodiment, a gateway 634 is provided as a hinged panel that is movable between a first position and second position. In the first position, access to the chip receptacle 606 is restricted. In the second position, access to the chip receptacle 606 is permitted.

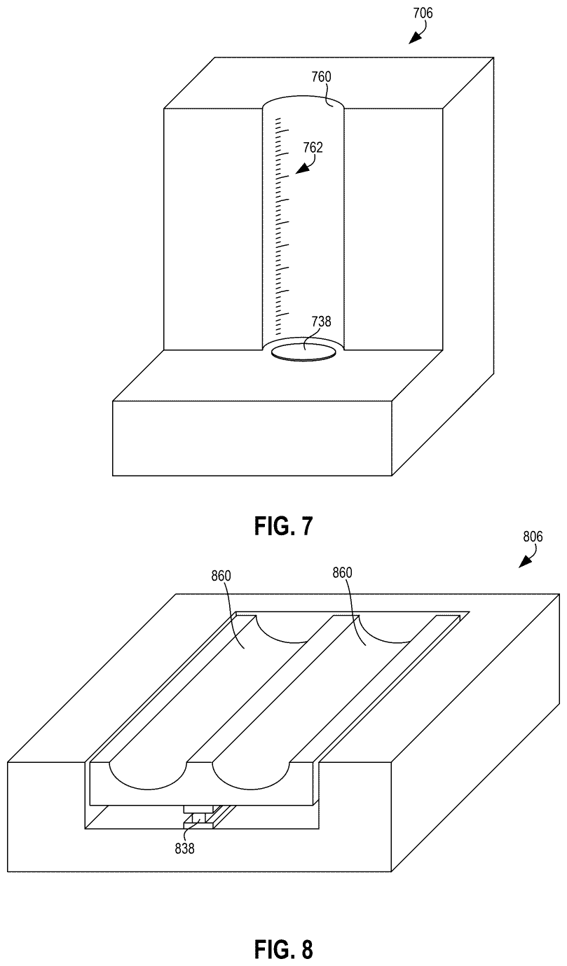

In various embodiments of the present invention, additional techniques can be employed to enhance the accuracy of chip detection and to mitigate the risk of fraudulent redemptions using decoy or counterfeit chips. FIG. 7 schematically illustrates a chip receptacle 706 in accordance with one non-limiting embodiment, which incorporates a ruler-based measurement system. As depicted in FIG. 7, the chip receptacle 706 includes a surface 760 upon which a ruler 762 is printed or embossed. This ruler 762 can serve as a visual scale that enables the measurement of the height of a stack of chips placed within the receptacle 706. Thus, by capturing an image of the chip stack alongside the ruler 762, the system can accurately determine the vertical dimensions of the stack.

Each genuine chip used in the casino has a specific weight and thickness that adheres to strict manufacturing standards. By leveraging this information, the chip redemption unit 300 can calculate the expected height of a stack based on the total weight of the chips, as determined by a chip scale 738. The chip scale 738, which can be integrated into the chip receptacle 706, can measure the cumulative weight of the chips placed in the chip receptacle 706. By comparing this weight measurement to the predefined weight of a single standard chip, the system can compute the total number of chips present in the stack. Any significant discrepancies between the measured and expected stack heights can indicate potential fraud or the presence of decoy chips. Decoy chips, which may have different weights or thicknesses compared to genuine casino chips, would result in inconsistencies between the weight-based chip count and the visually observed stack height. By detecting such anomalies, the chip redemption system can identify and flag potentially fraudulent redemption attempts.

While FIG. 7 illustrates a visual ruler 762 as the means for measuring chip stack height, this disclosure is not so limited. In some embodiments, advanced image processing algorithms, such as edge detection and object height estimation, can be applied to the captured images to accurately determine the stack height without relying on a physical ruler. Additionally, technologies like LiDAR (Light Detection and Ranging) or laser sensors can be integrated into the chip receptacle to provide precise depth measurements of the chip stack.

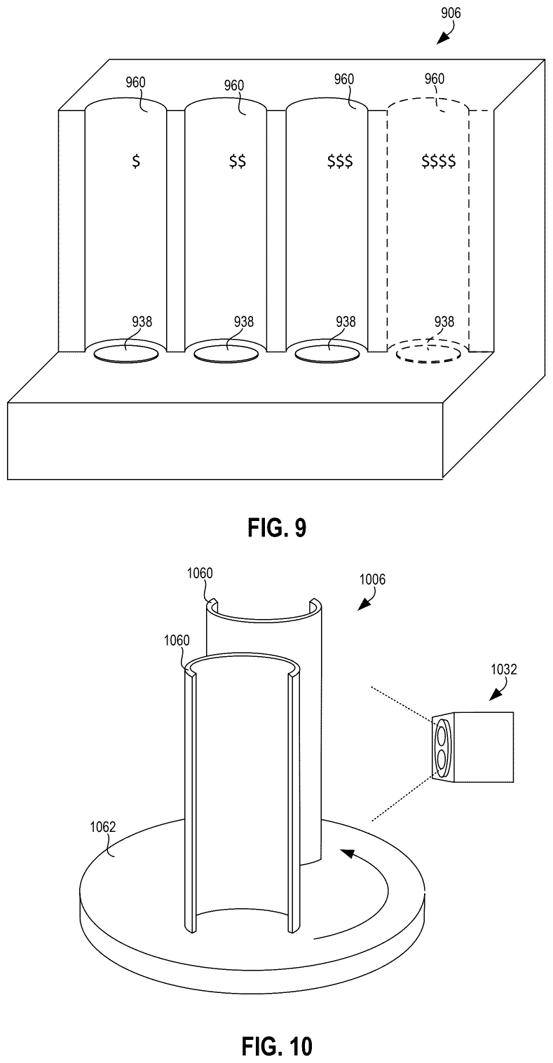

FIG. 8 schematically depicts another chip receptacle 806 in accordance with one non-limiting embodiment. In this embodiment, the chip receptacle 806 is generally configured similarly to a dealer chip tray, designed to receive stacks of chips in a horizontal orientation in individual troughs 860. As shown, a chip scale 838 can be integrated into the chip receptacle 806, with a tare function configured to subtract out the weight of the troughs 860. While two troughs 860 are shown in FIG. 8, it is to be readily appreciated that any suitable number of troughs 860 can be used in a chip redemption kiosk without departing from the scope of the present disclosure. FIG. 9 schematically depicts a chip receptacle 906 in accordance with one non-limiting embodiment that is calibrated to receive chips of certain denominations within certain troughs 960. By way of example, the user can be instructed to place chips having a certain denomination into one of the troughs and chips having a different denomination into another one of the troughs. The machine vision models used to analyze the chips in each trough can be specially tuned to the specific denominations, therefore increasing the speed and accuracy of the chip identification.

FIG. 10 schematically depicts a rotating chip receptacle 1006 in accordance with one non-limiting embodiment. In this embodiment, chip receptacle 1006 includes a plurality of chip holders 1060 mounted on a rotating platter 1062. Once chips are placed within one or more of the chip holders 1060, the platter 1062 can be rotated to bring each of the chip holders 1060 within the field of a view of a camera system 1032 for image processing and chip identification.

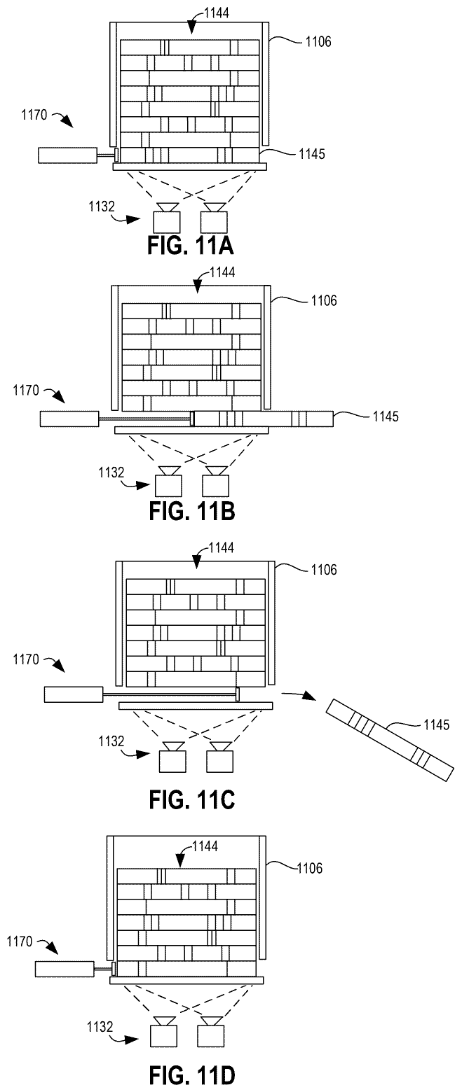

While many embodiments described herein identify chips via the outer periphery of each chip in stack, this disclosure is not so limited. FIGS. 11A-11D schematically depict embodiments in which the planar surface of each chip in a stack of chips 1144 can be visually inspected rapidly and efficiently to determine the value of each chip. Additionally, some casino chips include various security markers embedded or otherwise provided on the planar surface of the chip. Example security markers include microdots with micro printing, UV or IR signatures, among others. Beneficially, the chip identification process depicted in FIGS. 11A-11D can detect such security markers and, in the event that such security markers are not detected or not otherwise verified, the chip redemption transaction can be automatically halted, and appropriate messaging can be dispatched to casino personnel.

As schematically shown in FIGS. 11A-11D, a camera system 1132 can be positioned proximate to a chip receptacle 1106. Depending on the security markers expected to be on the chips 1144, the camera system 1132 can include, for example, a UV light, and IR light, or other system specially configured to reveal the security marker during the chip identification process. In the illustrated embodiment, an actuator 1170 is positioned proximate to the bottom chip of the chip stack 1144, shown as chip 1145. Once the chip has been identified and verified, the actuator 1170 can extend a plunger to push the chip 1145 out of the chip stack 1144, as shown in FIG. 11B. Once the bottom chip 1145 is pushed out of the chip stack 1144, the remaining chips in the chip stack 1144 can fall downward such that the next chip in the stack can be identified and verified, as shown in FIG. 11D.

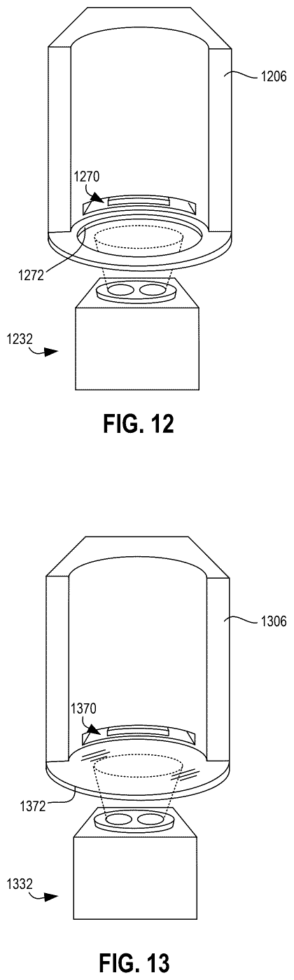

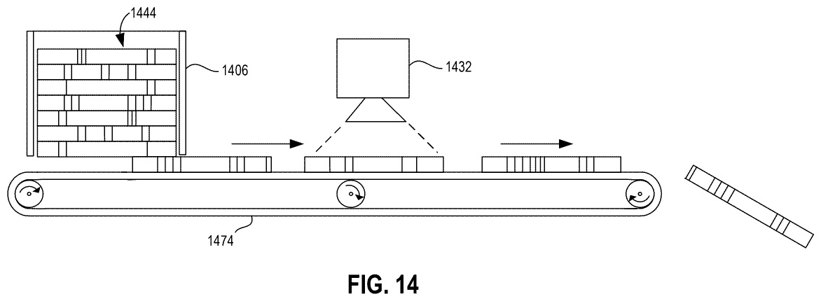

As is to be appreciated, various configurations can be used to allow a camera system to collect imagery from a bottom chip in a chip stack. FIG. 12, for example, schematically depicts a chip receptacle 1206 that defines an aperture 1272 in accordance with one non-limiting embodiment. The aperture 1272 can be smaller than the diameter of a casino chip, but large enough so that a camera system 1232 can collect the necessary information from the planar surface of the chip before an actuator 1270 removes the chip from the chip receptacle 1206. FIG. 13 schematically depicts another example chip receptacle 1306 in accordance with one non-limiting embodiment. In this embodiment, a bottom plate 1372 is translucent, thereby allowing a camera system 1332 to collect the necessary information from the planar surface of the chip before an actuator 1370 removes the chip from the chip receptacle 1306. FIG. 14 schematically depicts another example approach for identifying chips in a chip stack 1444 that have been placed in a chip receptacle 1406 in accordance with one non-limiting embodiment. In this example, a conveyor assembly 1474 is positioned proximate to the chip receptacle 1406 such that each chip in the chip stack 1444 is individually fed onto the conveyor assembly 1474. Once on the conveyor assembly 1474, each chip can be conveyed through the field of view of a camera system 1432 for identification and verification.

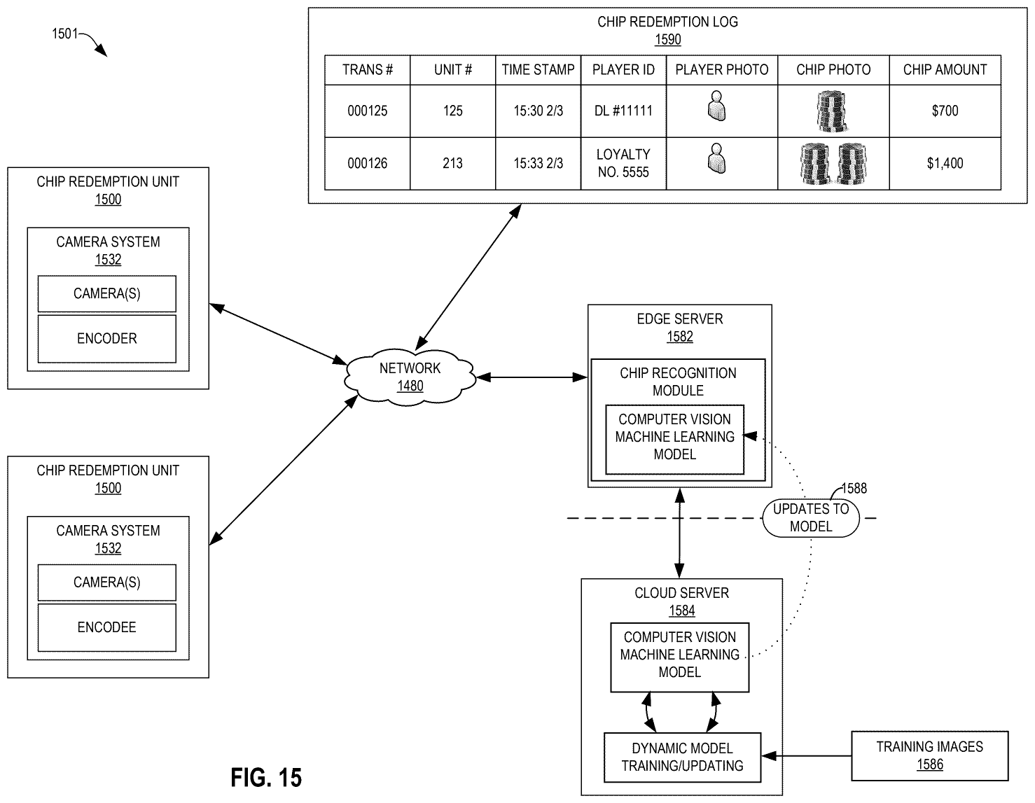

FIG. 15 schematically depicts a chip recognition system 1501 in accordance with one non-limiting embodiment. The chip recognition system 1501 can include a chip redemption units 1500 that can be positioned throughout a casino floor, for example. The chip redemption units 1500 can each house a variety of components, such as a camera system 1532 for chip identification. The camera system 1532 can include at least one high-definition camera and an encoder. The encoder can compress and convert the raw visual data captured by the high-definition camera into a format that is more efficient for storage or transmission. The encoder can employ any suitable encoding protocol, such as H.264, H.265, VP9, MPEG-2, MPEG-4 Part 2, among others, to compress video data collected by the camera so that it can be provided to an edge server 1582 via a communications network 1480. The communications network 1480 can utilize wired or wireless connections, including but not limited to Ethernet, Wi-Fi, cellular networks, or a combination thereof. As is to be appreciated, relevant security measures can be employed by the communications network 1480, such as encryption protocols, firewalls, or authentication mechanisms.

As is known in the art, an edge server 1582 is a type of server that is located closer to the end users or devices it serves, typically at the edge of a network or closer to the network's access points. Here, the edge server 1582 can be placed within the gaming environment and in relatively close proximity to the chip redemption units 1500 to aid in optimizing content delivery and reducing latency. The edge server 1582 can perform tasks such as processing data, running applications, and executing specific functions at the network edge. In accordance with the present disclosure, the edge server 1582 can include a chip recognition module that is used to identify the chips placed within the chip receptacle of a chip redemption unit 1500 based on the encoded video feed captured by the camera system 1532. More specifically, images of the chips placed within the chip receptacle by a user can be analyzed, via a computer vision machine learning model stored locally by the edge server 1582, to assess the value and quantity of chips being redeemed at the chip redemption unit 1500. In some example embodiments, the computer vision machine learning model can be initially trained on a large dataset of actual or synthetic images. During the training process, the model can learn patterns and features that distinguish different objects in the images. It tries to find relationships between pixel values, shapes, textures, and other visual characteristics that are indicative of specific objects. The chip recognition module can use any suitable object detection algorithms and architectures, such as Faster R-CNN, YOLO (You Only Look Once), and SSD (Single Shot MultiBox Detector), for example.

In accordance with the present disclosure, a cloud server 1584 associated with the gaming environment can also store a version of the computer vision machine learning model. The cloud server 1584 does not necessarily need to physically be on-site and can be deployed as a virtual infrastructure. The version of the computer vision machine learning model stored by the cloud server 1584 can initially be the same version as is deployed on the edge server 1582. The computer vision machine learning model, however, can be trained using a plurality of training images 1586 and/or other synthetic training data using various training techniques. Such training can utilize, for example, actual images of the chips from the gaming environment. In some embodiments, a user interface of the cloud server 1584 allows for the review and validation of the object detection such that the overall accuracy can be improved. Through the testing and training performed at the cloud server 1584, the computer vision machine learning model can be updated and improved over time. Subsequently, such updates 1588 can be pushed to the edge server 1582 (i.e., via an API) such that the computer vision machine learning model receives the benefit of the improved model thereby allowing it to be dynamically and iteratively updated. Such updates 1588 can be provided to the edge server 1582 routinely, such as on a particular schedule (i.e., daily, weekly, etc.), or otherwise provided whenever updates are available. Such an approach to deploying an initial model on-premises and then iteratively improving the model in a cloud-based environment, can beneficially allow for an initial deployment and then a rapid increase in the accuracy of object detection.

The presently disclosed system can also include a robust logging and tracking system to monitor and record chip redemption transactions at each of the chip redemption units 1500. As schematically illustrated in FIG. 15, the system can maintain a detailed chip redemption log 1590 that captures and stores relevant information for each chip redemption transaction processed or attempted at the chip redemption units 1500 within the casino. High-resolution images of the chips presented for redemption, as captured by the camera system 1532, can be stored in the chip redemption log 1590, providing a visual record of the specific chips involved in each transaction. The camera system 1532 may include multiple cameras positioned at different angles to ensure comprehensive coverage and to facilitate the accurate identification and authentication of the chips. In addition to capturing images of the chips, the chip redemption units 1500 may also include an onboard camera (such as camera 224 shown in FIG. 2) for capturing images of the users interacting with the machine. These user images can be stored in the chip redemption log 1590, associated with the corresponding transaction. By recording both chip and user images, the system can establish a comprehensive audit trail that links each redemption transaction to the specific individual who initiated it.

As is to be appreciated, the information collected and stored in the chip redemption log 1590 can assist with various functions within the casino's operations. Firstly, it enables detailed auditing and reconciliation processes, allowing casino management to verify the accuracy and integrity of chip redemption transactions occurring at the unmanned chip redemption units 1500. Secondly, the chip redemption log 1590 can facilitate the generation of comprehensive reports and analytics. These reports can provide valuable insights into chip redemption patterns, user behavior, and machine utilization. By analyzing this data, casino operators can optimize their chip management strategies, identify potential bottlenecks or inefficiencies, and make data-driven decisions to improve overall operational efficiency.

Importantly, the chip redemption log 1590 can also play a role in fraud detection and prevention. By maintaining a detailed record of each transaction, including chip and user images, the system enables swift identification and investigation of suspicious activities. Unusual redemption patterns, frequent redemptions by the same user, or attempts to redeem counterfeit chips can be flagged for further review.

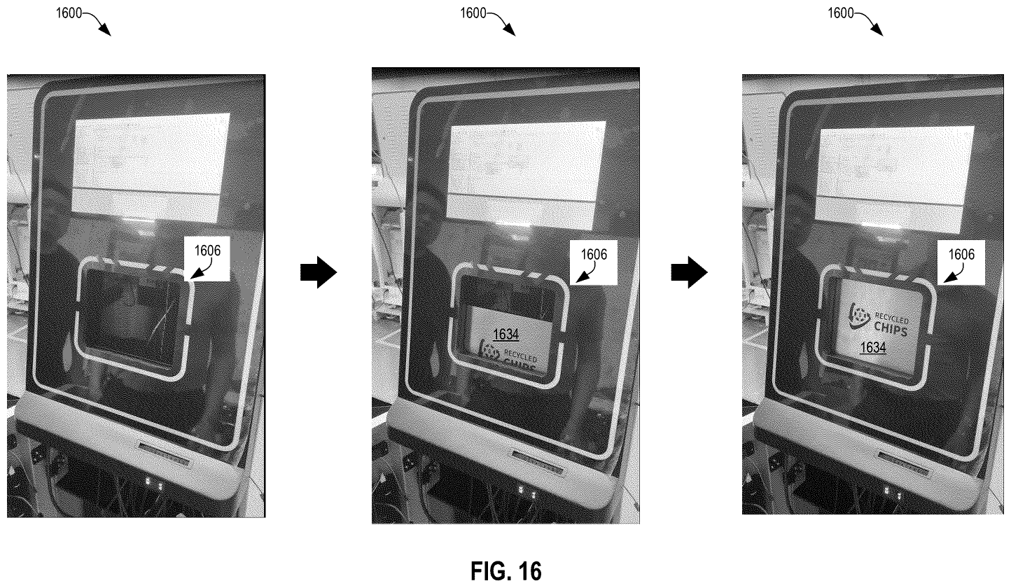

FIG. 16 shows an operational progression of an example chip receptacle 1606 of a chip redemption unit 1600 in accordance with one non-limiting embodiment. In this example progression, a gateway 1606 is initially in a retracted position, thereby providing access to the chip receptable 1606. As shown, after one or more chips are placed inside the chip receptable 1606 for processing by the chip redemption unit 1600, the gateway 1634 can vertically slide to close and secure the chip receptacle 1606. When the gateway 1634 is in the closed position, the chip redemption unit 1600 can perform various chip value identification processes, as described herein. Any suitable mechanical control can be used to move the gateway 1606 between the retracted position (open) and the extended position (closed), such as a linear actuator, a belt drive, a rack and pinion, a motorized lead screw, among others. Further, while the gateway 1634 is opaque in FIG. 16, in other embodiments at least a portion of the gateway 1634 can be transparent.

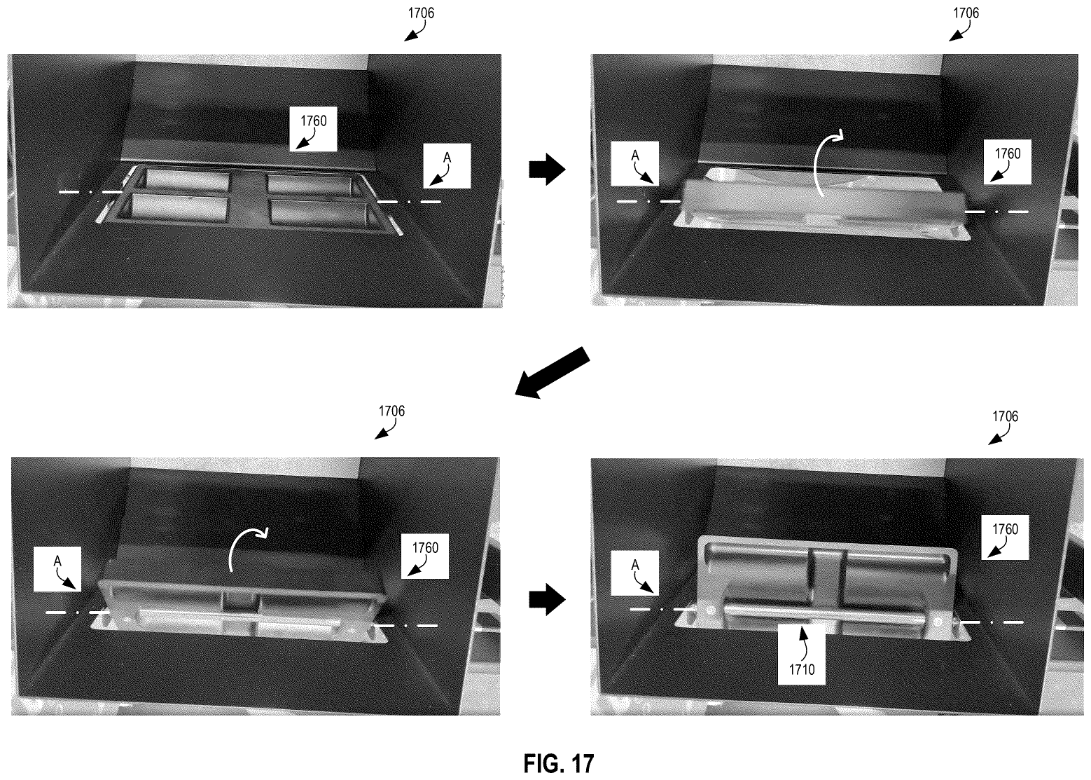

FIG. 17 schematically depicts a chip receptacle 1760 of a chip redemption kiosk having a pivoting chip tray 1760. In this example embodiment, the pivoting chip tray 1760 is selectable rotatable about an axis A. As shown, the pivoting chip tray 1760 is configured to dump chips that are positioned on the tray into a hopper (not shown) positioned beneath the chip tray 1760. The chip tray 1760 is initially positioned horizontally, providing troughs to receive chips for redemption. The chip tray 1760 can be mounted on a support structure that allows for rotational movement about the lateral axis A. In this example embodiment, a rod 1710 extends laterally through the chip tray 1760. This rod 1710 can serve as the axis of rotation for the chip tray 1760. The ends of the rod 1710 can be mounted on bearings or bushings within the chip redemption kiosk. As is to be appreciated, however, beyond using a rod 1710, other arrangements can be used to allow the chip tray 1760 to rotate about the axis A. A hopper (not shown) can be positioned beneath the chip tray 1760 to collect the chips from the chip tray 1760 when it is rotated. The chip tray 1760 can be equipped with an automatic rotation mechanism that enables controlled tilting or rotation of the chip tray 1760 about the axis A. This mechanism can be powered by various means, such as an electric motor, a pneumatic actuator, or a hydraulic system, depending on the specific requirements of the application. When the rotation mechanism is activated, it applies a torque to the rod 1710, causing the chip tray 1760 to rotate about the lateral axis, as shown in FIG. 17. As the tray tilts, any chips held in the troughs will fall into the hopper positioned below.

Any element expressed herein as a means for performing a specified function is intended to encompass any way of performing that function, including a combination of elements that perform that function. Furthermore, the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

Moreover, the processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A non-transitory computer-readable medium may also include memory storage that may be physical, virtual, permanent, temporary, semi-permanent and/or semi-temporary.

A “computer,” “computer system,” “host,” “engine,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as tracking demand for processing power from different machines, prioritizing and scheduling tasks based on network demand, and/or providing backup contingency in the event of component failure or reduction in operability.

The examples presented herein are intended to illustrate potential and specific implementations. It can be appreciated that the examples are intended primarily for purposes of illustration of the invention for those skilled in the art. No particular aspect or aspects of the examples are necessarily intended to limit the scope of the present disclosure. No particular aspect or aspects of the examples of system architectures, table layouts, or report formats described herein are necessarily intended to limit the scope of the disclosure.

In general, it will be apparent to one of ordinary skill in the art that various embodiments described herein, or components or parts thereof, may be implemented in many different embodiments of software, firmware, hardware, or modules thereof. The software code or specialized control hardware used to implement some of the present embodiments is not limiting of the present invention. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present disclosure based on the description herein with only a reasonable effort and without undue experimentation.

In various embodiments, the systems and methods described herein may be configured and/or programmed to include one or more of the above-described electronic, computer-based elements, and components. In addition, these elements and components may be particularly configured to execute the various rules, algorithms, programs, processes, and method steps described herein.

While various embodiments have been described herein, it should be apparent that various modifications, alterations and adaptations to those embodiments may occur to persons skilled in the art with the attainment of some or all of the advantages of the present disclosure. The disclosed embodiments are therefore intended to include all such modifications, alterations, and adaptations without departing from the scope and spirit of the present disclosure as set forth in the appended claims.

1. A chip redemption system, comprising:
a chip receptacle configured to receive multiple casino chips simultaneously;
a chip identification system positioned within the chip receptacle and configured to identify and verify the multiple casino chips;
a controller operatively connected to the chip identification system; and
a value dispenser configured to provide a user with a value corresponding to the identified and verified multiple casino chips.

2. The chip redemption system of claim 1, wherein the chip identification system comprises an RFID reader configured to read RFID tags embedded in the casino chips.

3. The chip redemption system of claim 1, wherein the chip identification system comprises a camera system configured to capture images of the multiple casino chips.

4. The chip redemption system of claim 3, wherein the chip identification system further comprises an image processor configured to analyze the captured images to identify and verify the multiple casino chips.

5. The chip redemption system of claim 1, wherein the chip receptacle comprises a gateway movable between an open position allowing access to the chip receptacle and a closed position restricting access to the chip receptacle.

6. The chip redemption system of claim 5, further comprising an electronic lock configured to secure the gateway in the closed position during chip identification and verification.

7. The chip redemption system of claim 1, further comprising a chip scale configured to weigh the multiple casino chips placed in the chip receptacle.

8. The chip redemption system of claim 7, wherein the controller is configured to compare a measured weight of the multiple casino chips from the chip scale with an expected weight based on the identified and verified multiple casino chips to detect potential fraud.

9. A method of redeeming casino chips, comprising:
receiving multiple casino chips simultaneously in a chip receptacle;
identifying and verifying the multiple casino chips using a chip identification system positioned within the chip receptacle;
determining a total value of the identified and verified multiple casino chips; and
dispensing a corresponding value to a user.

10. The method of claim 9, wherein identifying and verifying the multiple casino chips comprises reading RFID tags embedded in the multiple casino chips using an RFID reader.

11. The method of claim 9, wherein identifying and verifying the multiple casino chips comprises capturing images of the multiple casino chips using a camera system positioned within the chip receptacle.

12. The method of claim 11, further comprising analyzing the captured images using an image processor to identify and verify the multiple casino chips.

13. The method of claim 9, further comprising:
weighing the multiple casino chips placed in the chip receptacle using a chip scale; and
comparing a measured weight of the multiple casino chips from the chip scale with an expected weight based on the identified and verified multiple casino chips to detect potential fraud.

14. The method of claim 9, further comprising:
securing a gateway of the chip receptacle in a closed position during chip identification and verification; and
unlocking the gateway to allow retrieval of the multiple casino chips if a user declines to complete the redemption process.

15. The method of claim 9, wherein dispensing the corresponding value to the user comprises at least one of: printing a ticket voucher, dispensing cash, or crediting a virtual wallet associated with the user.

16. The method of claim 15, further comprising:
capturing an image of the user interacting with the chip receptacle; and
storing the captured image along with transaction details in a chip redemption log.

17. A chip redemption kiosk, comprising:
a housing;
a user interface mounted on the housing;
a chip receptacle within the housing, the chip receptacle having a gateway movable between an open position allowing access to the chip receptacle and a closed position restricting access to the chip receptacle, wherein the chip receptacle is configured to receive multiple casino chips simultaneously;
a chip identification system configured to identify and verify the multiple casino chips placed in the chip receptacle; and
a controller operatively connected to the chip identification system and configured to control dispensing of value based on the identified and verified multiple casino chips.

18. The chip redemption kiosk of claim 17, wherein the chip identification system comprises an RFID reader and an RFID antenna configured to read RFID tags embedded in the multiple casino chips.

19. The chip redemption kiosk of claim 17, wherein the chip identification system comprises a camera system configured to capture images of the multiple casino chips placed in the chip receptacle.

20. The chip redemption kiosk of claim 19, wherein the chip identification system further comprises an image processor configured to analyze the captured images to identify and verify the multiple casino chips.
